(19) United States
(12) Patent Application Publication
(10) Pub. No.: US 2025/0101805 A1
(43) Pub. Date: Mar. 27, 2025

(54) LADDERS, LADDER ACCESSORIES, COMPONENTS THEREOF, AND ADJUSTABLE PLATFORMS FOR USE THEREWITH

(71) Applicant: Werner Co., Greenville, PA (US)

(72) Inventors: Vlatko Papa, Park Ridge, IL (US); Derek Bibler, Charlotte, NC (US)

(21) Appl. No.: 18/890,135

(22) Filed: Sep. 19, 2024

Related U.S. Application Data
(60) Provisional application No. 63/540,429, filed on Sep. 26, 2023.

(51) Int. Cl. E06C 1/393

(52) U.S. Cl. CPC E06C 1/393

(57) ABSTRACT

Provided herein are ladders including adjustable platforms. In some embodiments, a ladder may include a front rail assembly with a first front rail and a second front rail. The ladder further includes a rear rail assembly coupled to the front rail assembly. The rear rail assembly includes a first rear rail and a second rear rail. The first rear rail has a first track. The second rear rail has a second track. The first and second tracks extend from a first position to a second position. The front rail assembly includes a first pair of brackets at the first position and a second pair of brackets at the second position. The ladder further includes a platform with a first projection that engages the first track and a second projection that engages the second track. The platform is moveable along the first and second tracks between the first and second positions.

### CROSS-REFERENCE TO RELATED APPLICATION

This application claims the benefit of U.S. Provisional Application No. 63/540,429 filed Sep. 26, 2023, which is incorporated herein by reference in its entirety.

### TECHNICAL FIELD

This disclosure relates generally to ladders and, more specifically, to platforms for ladders.

### BACKGROUND

Ladders typically provide access to elevated locations and/or items and may be used in a variety of locations. Depending on the location and/or typical operating conditions in those locations, one or more features or accessories may be utilized with the ladder or built into the ladder to improve stability and/or usability.

For example, a ladder, such as podium ladder, may include a platform having a larger area than steps or rungs of the ladder. The platforms may provide stable and secure working surfaces on which a user may stand and/or place equipment. The platform, however, may be at a fixed position on the ladder and, accordingly, may not provide the flexibility to work at different heights using a single ladder.

### BRIEF DESCRIPTION OF DRAWINGS

Various needs are at least partially met through the provision of the ladder or similar structure having an adjustable platform described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 comprises a front top perspective view of a ladder having an adjustable platform;

FIG. 2 comprises a rear top perspective view of the ladder of FIG. 1;

FIG. 3 comprises a left perspective view of the ladder of FIG. 1;

FIG. 4 comprises a right perspective view of the ladder of FIG. 1;

FIG. 5 comprises an enlarged view of a portion of a ladder including the encircled area 5-5 of FIG. 4;

FIG. 6 comprises an enlarged exploded view of a portion of a ladder including the encircled area 5-5 of FIG. 4;

FIG. 7A comprises an enlarged bottom perspective view of a portion of the ladder of FIG. 1;

FIG. 7B comprises the enlarged bottom perspective view of FIG. 7A, illustrating the pins that engage the rails of the ladder;

FIG. 8A comprises a right elevation view of a portion of the first track of the ladder of FIG. 1;

FIG. 8B comprises a left elevation view of a portion of the second track of the ladder of FIG. 1;

FIG. 9 comprises a right perspective view of the platform of the ladder of FIG. 1 at a first position;

FIG. 10 comprises a right perspective view of the platform of the ladder of FIG. 1 traveling between a first position and a second position;

FIG. 11 comprises a right perspective view of the platform of the ladder of FIG. 1 traveling between a first position and a second position;

FIG. 12 comprises a right perspective view of the platform of the ladder of FIG. 1 at a second position;

FIG. 13 comprises a schematic diagram of an exemplary track that provides three secured or stable positions for a platform on a ladder;

FIG. 14 comprises a perspective view of a ladder having an adjustable platform, in accordance with some embodiments; and

FIG. 15 comprises a right side view of the ladder of FIG. 14.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Provided herein is a ladder or other similar structure that includes an adjustable platform. The ladder, for example, may be a podium ladder having a platform disposed between a first rail assembly and a second rail assembly. In one illustrative approach, one end of the adjustable platform includes projections that engage tracks incorporated into rails of the first rail assembly. In this manner the adjustable platform is moveable along the tracks between at least two positions (e.g., a first position and a second position) on the ladder. Another end of the adjustable platform includes a lock assembly that includes rods to engage brackets on the second rail assembly. The lock assembly has one or more locked positions (and, in some aspects, at least two) in which the platform is secured to the second rail assembly in, e.g., the first position or the second position. The lock assembly also typically has an unlocked position in which the platform is moveable between the first position and the second position. In the unlocked position, a user may slide the adjustable platform along the tracks of the first rail assembly to raise or lower the platform to the first position or the second position.

The adjustable platform described herein may be integrated into any railed structure. A railed structure may include, for example, a rail assembly having two or more vertical components (e.g., rails, tubes, etc.) joined together by at least one horizontal component (e.g., steps, rungs, tubes, etc.). In some non-limiting configurations, the vertical components may have a box, channel, or C-shaped profile. The railed structures include, but are not limited to, ladders, scaffolds, and work platforms.

In some aspects, the techniques described herein relate to a ladder including a rear rail assembly including a first rear rail a second rear rail spaced from and opposite the first rear rail. The first rear rail has a first track. The second rear rail has a second track that is opposite and aligned with the first track. The ladder further includes a platform that includes a first projection that engages the first track and a second projection that engages the second track, such that the platform is moveable along the first track and the second track between at least a first position and a second position on the ladder.

The ladder may further include a front rail assembly coupled to the rear rail assembly via a hinged portion. The front rail assembly includes a first pair of brackets disposed at the first position and a second pair of brackets disposed at the second position.

In some aspects, the techniques described herein relate to a ladder including a front rail assembly including a first front rail and a second front rail spaced from and opposite the first front rail. By some approaches, first pair of brackets is coupled to the front rail assembly at a first position. In some configurations, a second pair of brackets coupled to the front rail assembly at a second position. The ladder further includes a rear rail assembly coupled to the front rail assembly at a hinged portion. The rear rail assembly typically includes a first rear rail and a second rear rail spaced from and opposite the first rear rail. The first rear rail has a first track. The second rear rail has a second track that is opposite and aligned with the first track. The ladder further includes a platform that is positioned between the front rail assembly and the rear rail assembly. The platform includes a first projection that engages the first track and a second projection that engages the second track, such that the platform is moveable along the first track and the second track between the first position and the second position.

In some aspects, the techniques described herein relate to a ladder including a front rail assembly including a first front rail and a second front rail spaced from and opposite the first front rail. The ladder further includes a rear rail assembly coupled to the front rail assembly at a hinged portion. The rear rail assembly includes a first rear rail and a second rear rail spaced from and opposite the first rear rail. The ladder also includes a first pair of brackets disposed at a first position along the ladder and a second pair of brackets disposed at a second position along the ladder. The first pair of brackets and the second pair of brackets are coupled to one of the front rail assembly and the rear rail assembly. The ladder further includes a first track and a second track extending from the first position to the second position. The first track and the second track are disposed on the other one of the front rail assembly and the rear rail assembly. In some approaches, the first track and the second track may be disposed on either one of the front rail assembly or the rear rail assembly. The ladder also has a platform positioned between the front rail assembly and the rear rail assembly. In one illustrative approach, the platform includes a first projection that engages the first track and a second projection that engages the second track, such that the platform is moveable along the first track and the second track between the first position and the second position.

The terms and expressions used herein have the ordinary technical meaning as is accorded to such terms and expressions by persons skilled in the technical field as set forth above except where different specific meanings have otherwise been set forth herein. The word “of” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

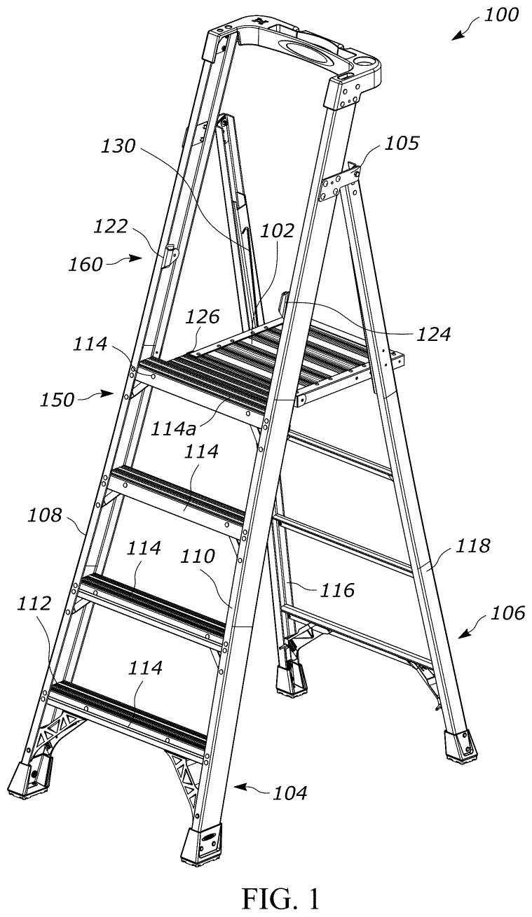

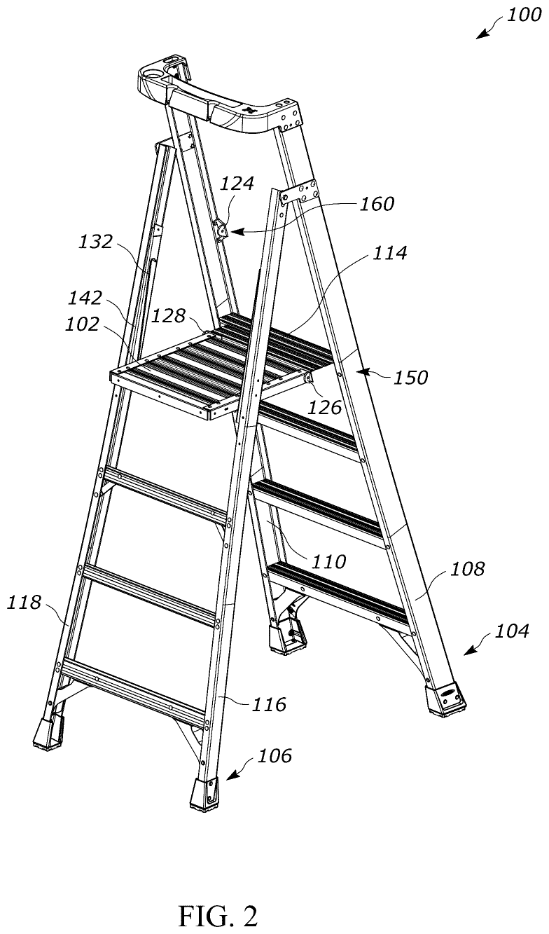

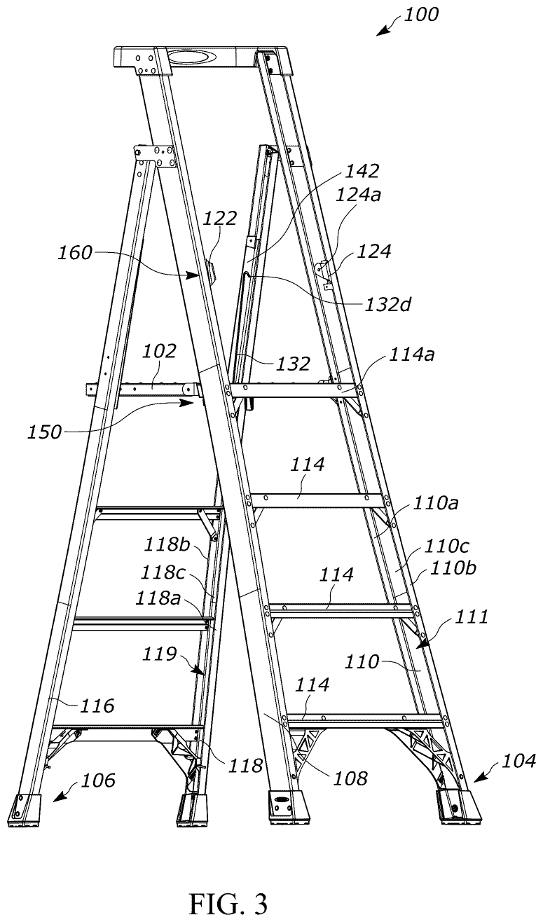

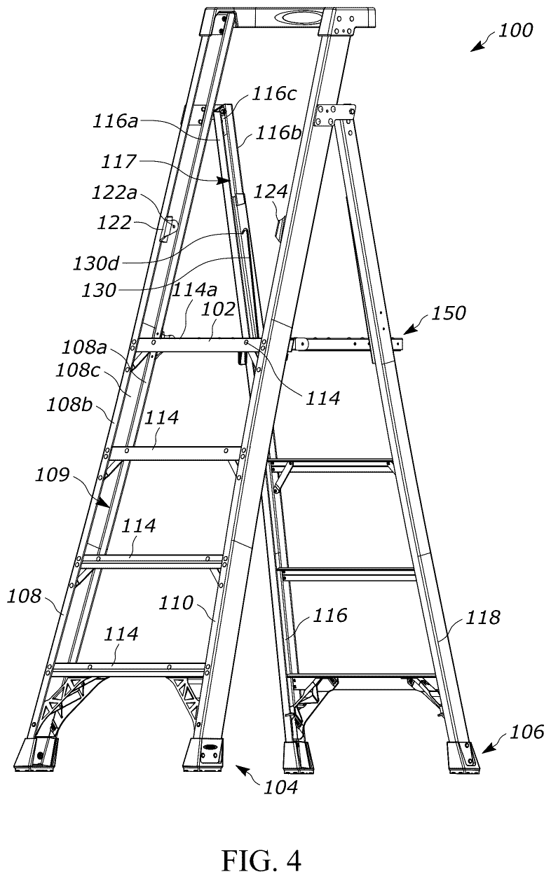

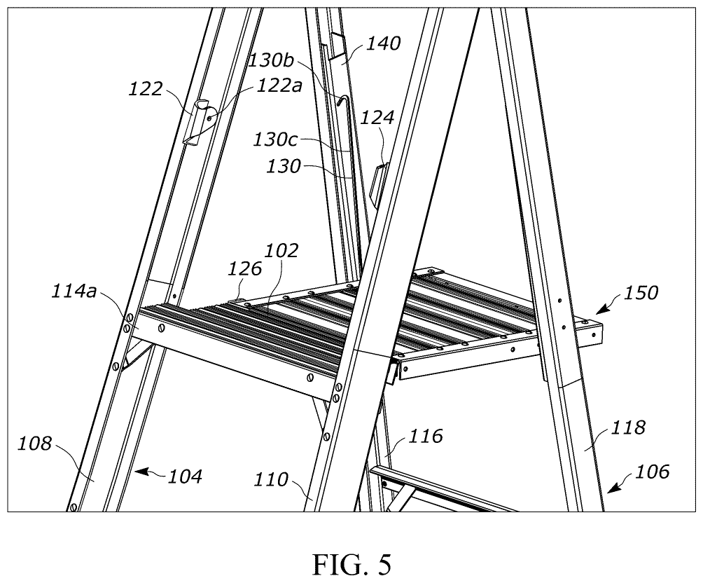

Referring now to the drawings, and in particular to FIGS. 1-7, a ladder 100 including a platform 102 that is adjustable is shown. The platform 102 may be adjusted between at least two positions along the ladder 100. FIGS. 1-7 show the platform 102 of the ladder 100 in a first position 150. For example, as illustrated in FIGS. 9-12, the platform 102 may be adjusted between the first position 150 and a second position 160.

The ladder 100 is a step ladder having a front rail assembly 104 and a rear rail assembly 106. The front rail assembly 104 is coupled to the rear rail assembly 106 at a hinged portion 105. The front rail assembly 104 includes a first front rail 108 spaced from and opposite a second front rail 110. The first front rail 108 is parallel to the second front rail 110. The front rail assembly 104 further includes a plurality of rungs or steps 114 disposed between the first front rail 108 and the second front rail 110. The rear rail assembly 106 includes a first rear rail 116 spaced from and opposite a second rear rail 118. The first rear rail 116 is parallel to the second rear rail 118. The platform 102 is positioned between the front rail assembly 104 and the rear rail assembly 106.

In one illustrative configuration, the first front rail 108, the second front rail 110, the first rear rail 116, and the second rear rail 118 are C-shaped. The rails of the ladder 100, however, may be any suitable shape. For example, the rails of the ladder 100 may alternatively be round having a generally circular cross-section, D-shaped having a flat side that rests against the ladder steps or rungs, and a curved side, square or rectangular shaped, I-beam shaped having a cross-sectional shape generally resembling the letter “I”, or box-sections having a square or rectangular cross-sectional shape with a hollow interior.

In some configurations, the first front rail 108 includes a first front inner flange 108a spaced from a first front outer flange 108b by a first front web 108c. The first front inner flange 108a, the first front outer flange 108b, and the first front web 108c form a first front channel 109 that extends through the first front rail 108. The second front rail 110 includes a second front inner flange 110a spaced from a second front outer flange 110b by a second front web 110c. The second front inner flange 110a, the second front outer flange 110b, and the second front web 110c form a second front channel 111 that extends through the second front rail 110. The first rear rail 116 includes a first rear inner flange 116a spaced from a first rear outer flange 116b by a first rear web 116c. The first rear inner flange 116a, the first rear outer flange 116b, and the first rear web 116c form a first rear channel 117. The second rear rail 118 includes a second rear inner flange 118a spaced from a second rear outer flange 118b by a second rear web 118c. The second rear inner flange 118a, the second rear outer flange 118b, and the second rear rail 118 form a second rear channel 119 that extends through the second rear rail 118.

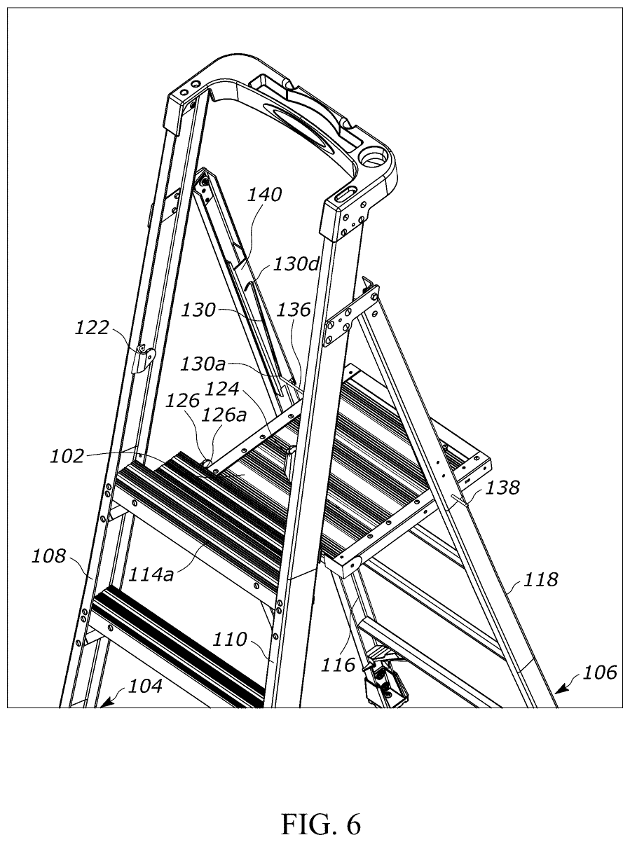

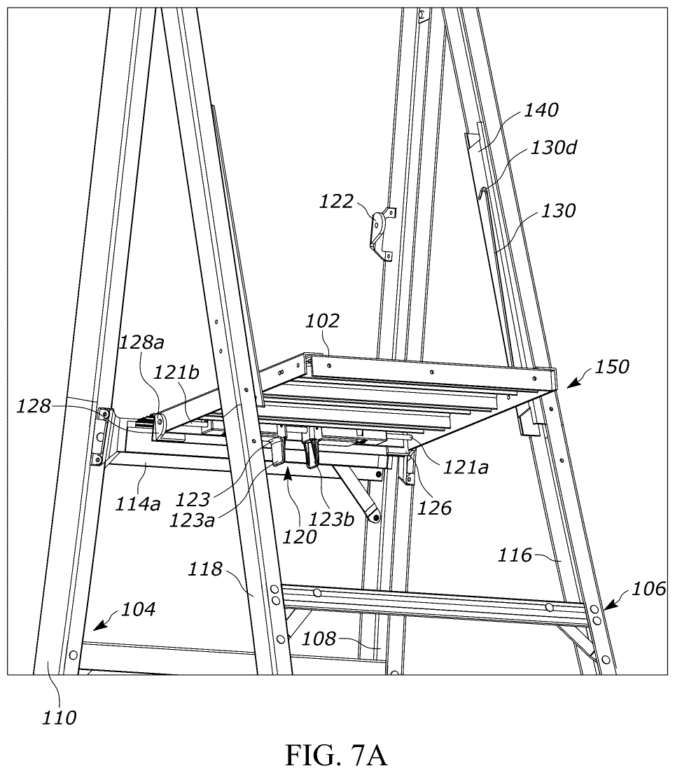

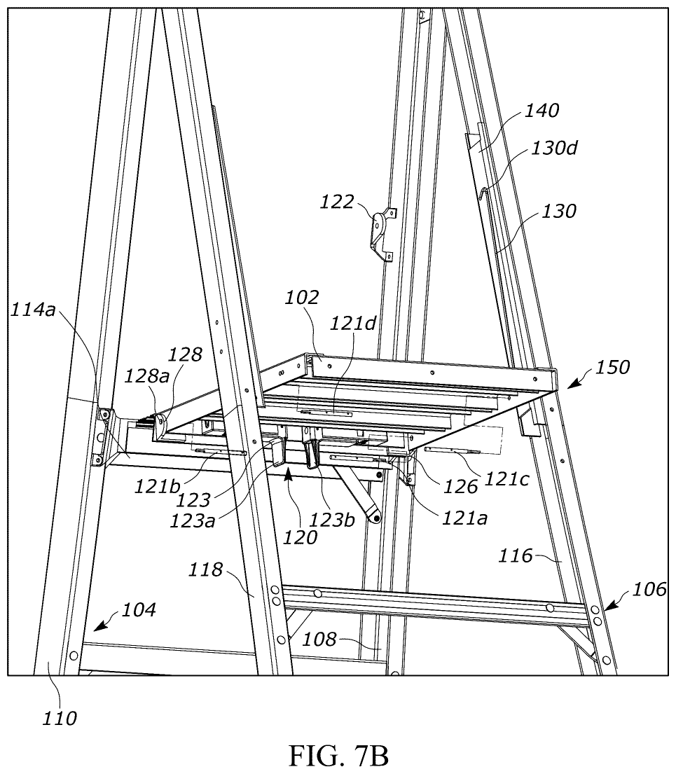

In one illustrative approach, the platform 102 includes a first rod 121a and a second rod 121b (see FIG. 7B) that are selectively engageable with the front rail assembly 104. The rods may engage a stop or other structure. For example, as is described in detail below, the first rod 121a and the second rod 121b selectively engage brackets (e.g., a first top bracket 122/second top bracket 124 or a first bottom bracket 126/a second bottom bracket 128) disposed on the front rail assembly 104. Further, the platform 102 includes a first projection 136 and a second projection 138 (see FIG. 6) that engage the rear rail assembly 106. As is also described further below, the first projection 136 and the second projection 138 engage tracks (e.g., a first track 130 and a second track 132) disposed in the rear rail assembly 106. While the illustrated embodiment includes a pair of rods 121a, 121b that engage with the brackets 126, 128, other structures such as cables or wires may be employed. In such a configuration a cable may be coupled to or engage with the pinch lock and a projection or other element that engages with the rails. For example, one or more cable assemblies may be operated by the pinch grasp portion to selectively engage pins or other projections with the rails. The cable assemblies may also include one or more tensioners to pick up slack in the cables.

Turning first to the interface of the platform 102 with the front rail assembly 104, the platform 102 includes a lock assembly 120 for selectively engaging the front rail assembly 104. The platform 102 includes the lock assembly 120 for securing and moving the platform 102 between a locked position in which the platform 102 is secured the front rail assembly 104 and an unlocked position in which the platform 102 is moveable between the first position 150 and the second position 160. In the unlocked position, the platform 102 is not secured to the front rail assembly 104 and is free to move relative to the front rail assembly 104. In the locked position, the platform 102 is fixed relative to the front rail assembly 104 and is generally unable to move relative to the front rail assembly 104. The platform 102 may include any lock assembly or suitable mechanism(s) for selectively engaging the front rail assembly 104 such as, for example, mounting clamps, rods, j-locks, brackets, or combinations thereof. It is also contemplated that the lock assembly 120 may be any of the lock assemblies or portions thereof described in International Application No. PCT/US23/12018 entitled “Ladders, Ladder Accessories, Components Thereof, and Lock Assemblies for Use Therewith” filed on Jan. 31, 2023.

In some embodiments, the lock assembly 120 includes a pinch grasp portion 123 that is operably coupled to the first rod 121a and the second rod 121b. The pinch grasp portion 123 has a first lever 123a and a second lever 123b that are coupled to the first rod 121a and the second rod 121b. In this manner, operating the pinch grasp portion 123 moves the first rod 121a and the second rod 121b inward (toward one another) causing the first rod 121a and the second rod 121b to disengage the front rail assembly 104. The pinch grasp portion 123 extends or depends from a bottom surface of the platform 102 so that the pinch grasp portion 123 does not interfere with the upper working surface of the platform 102.

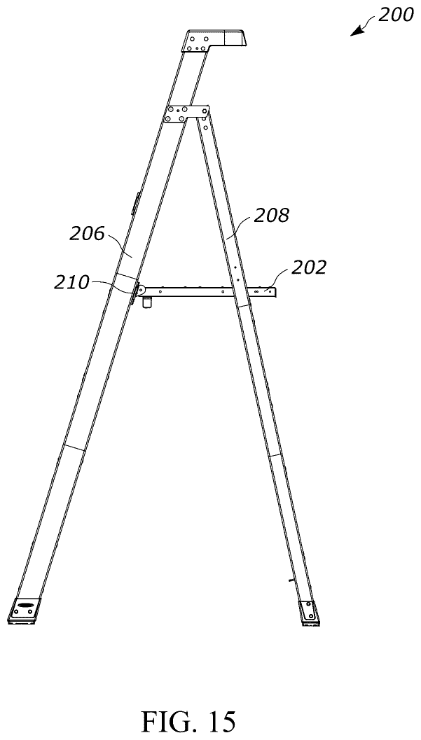

In one illustrative configuration, the front rail assembly 104 includes a first pair of brackets for securing the platform 102 to the front rail assembly 104 at the first position 150 via the rods 121a, 121b of the lock assembly 120. The first pair of brackets includes the first bottom bracket 126 and the second bottom bracket 128. The first pair of brackets is disposed at the first position 150 on the ladder 100. The first pair of brackets may be coupled to any suitable position on the front rail assembly 104. In some approaches, the first pair of brackets are coupled to one of the plurality of steps 114 of the front rail assembly 104. In one example, the first pair of brackets are coupled to a topmost step 114a of the plurality of steps 114. In another example (see e.g., FIGS. 14 and 15), the first pair of brackets are coupled to the flanges of the front rail assembly 104.

The topmost step 114a of the plurality of steps 114 may include an extended portion that overhangs or is cantilevered beyond the first front rail 108 or the second front rail 110. The first pair of brackets (e.g., first bottom bracket 126 and the second bottom bracket 128) may be coupled to the extended portion. So configured, the platform 102 is able to engage the first pair of brackets without interfering with the topmost step 114a. In some examples (see e.g., FIGS. 14 and 15), the front part may not have the extended portion and, instead, may be flush with the first front rail 108 and the second front rail 110.

The front rail assembly 104 further includes a second pair of brackets for securing the platform 102 to the front rail assembly 104 at the second position 160 via the rods 121a, 121b. The second pair of brackets typically includes a first top bracket 122 and a second top bracket 124. The first top bracket 122 and the second top bracket 124 are at the same vertical height on the front rail assembly 104. The first top bracket 122 includes a first top bracket opening 122a. The second top bracket 124 includes a second top bracket opening 124a. The second pair of brackets is disposed at the second position 160 on the ladder 100. The second pair of brackets may be coupled to any suitable position along the front rail assembly 104. As shown in FIGS. 1-7, the second pair of brackets are typically positioned above the first pair of brackets on the ladder.

Moving the first lever 123a and the second lever 123b of the pinch grasp portion 123 towards each other causes the first rod 121a and the second rod 121b to selectively engage either the first pair of brackets or the second pair of brackets. By operating the pinch grasp portion 123 a user may switch between the unlocked position, in which the rods 121a, 121b disengage the first or second pair of brackets, and a locked position, in which the rods 121a, 121b engage the first or second pair of brackets. It is contemplated that the pinch grasp portion 123 may facilitate one-handed operation of the lock assembly to simplify adjustment of the platform 102.

Turning next to the interface of the platform 102 with the rear rail assembly 106, the platform 102 includes the first projection 136, which is received by the first track 130, and the second projection 138, which is received by the second track 132. The first rear rail 116 of the rear rail assembly 106 includes the first track 130. The first track 130 is disposed between the first rear inner flange 116a and the first rear outer flange 116b of the first rear rail 116. The first track 130 is a first slot or groove in the first rear rail 116 that serves as a guide for the first projection 136. The first track 130 is disposed on an inward-facing portion of the first rear rail 116. The second rear rail 118 of the rear rail assembly 106 includes the second track 132. The second track 132 is disposed between the second rear inner flange 118a and the second rear outer flange 118b of the second rear rail 118. The second track 132 is a second slot or groove in the second rear rail 118 that serves as a guide for the second projection 138. The second track 132 is disposed on an inward-facing portion of the second rear rail 118.

In some embodiments, the first track 130 is formed in a first insert 140. The first insert 140 has a geometry corresponding to a geometry of the inward-facing portion of the first rear rail 116. The first insert 140 may be nested in the first rear channel 117. For example, the geometry of the first insert 140 may correspond to the geometry of the first rear channel 117. Similarly, the second track 132 may be formed in a second insert 142. The second insert 142 has a geometry corresponding to a geometry of the inward-facing portion of the second rear rail 118. For example, the geometry of the second insert 142 may correspond to the geometry of the second rear channel 119. The second insert 142 may be nested in the second rear channel 119. The first insert 140 and the second insert 142 may be secured to the first rear rail 116 and the second rear rail 118, respectively, using any suitable attachment mechanism. Suitable attachment mechanisms may include, for example, welding, brazing, adhesive, rivets, nuts and bolts, etc.

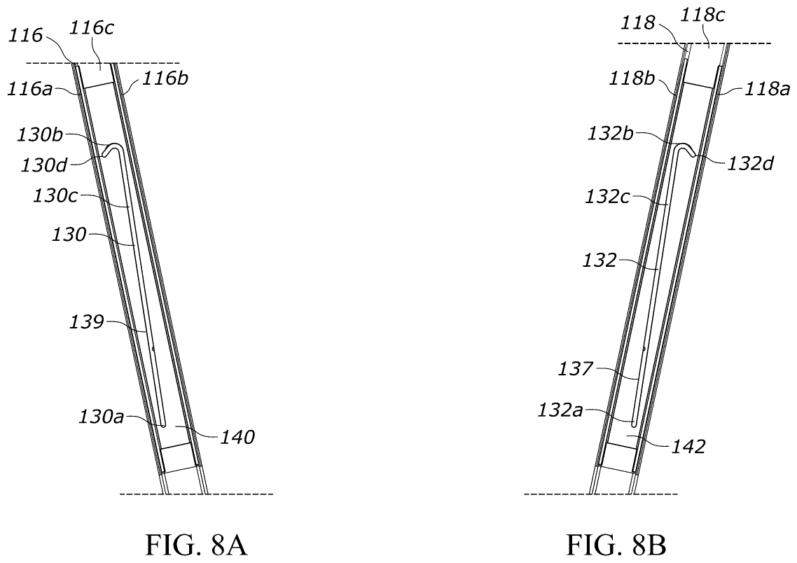

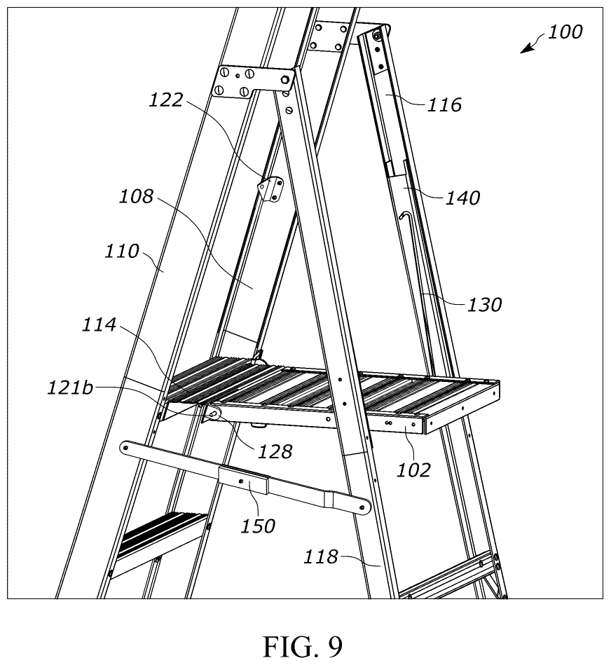

Turning to FIG. 8A, the first track 130 is disposed between the first rear inner flange 116a and the first rear outer flange 116b of the first rear rail 116. The first track 130 is a first opening positioned between two parallel edges 139 disposed in the first insert 140. In the example shown, the first track 130 has a candy-cane shape. The first track 130 includes a first base portion 130a, a first hooked portion 130b, and a first straight portion 130c disposed between the first base portion 130a and the first hooked portion 130b. The first hooked portion 130b of the first track 130 is disposed at or adjacent to the second position 160. The first base portion 130a of the first track 130 is disposed at or adjacent to the first position 150. The first straight portion 130c extends from the first position 150 to the second position 160. The first straight portion 130c is disposed at an angle relative to the first rear inner flange 116a and the first rear outer flange 116b. As a result, the first base portion 130a is closer to the first rear inner flange 116a than a bend in the first hooked portion 130b. When the ladder 100 is assembled, at least a portion of the first projection 136 of the platform 102 is positioned in the first track 130. In this manner, the first track 130 provides a travel path for the first projection 136 between the first position 150 and the second position 160.

Turning to FIG. 8B, the second track 132 is disposed between the second rear inner flange 118a and the second rear outer flange 118b of the second rear rail 118. The second track 132 is a second opening positioned between two parallel edges 137 formed in the second insert 142. The second track 132 has a candy-cane shape that is aligned with the candy-cane shape of the first track 130. Indeed, the second track generally mirrors the first track and while other suitable shapes or configurations may be employed, the two tracks will remain substantially similar. The second track 132 includes a second base portion 132a, a second hooked portion 132b, and a straight portion 132c disposed between the second base portion 132a and the second hooked portion 132b. The second hooked portion 132b is disposed at or adjacent to the second position 160. The second base portion 132a is disposed at or adjacent to the second hooked portion 132b. The straight portion 132c extends from the first position 150 to the second position 160. The straight portion 132c is disposed at an angle relative to the second rear inner flange 118a and the second rear outer flange 118b. As a result, the second base portion 132a is closer to the second rear inner flange 118a than a bend in the second hooked portion 132b. When the ladder 100 is assembled, at least a portion of the second projection 138 of the platform 102 is positioned in the second track 132. In this manner, the second track 132 provides a travel path for the second projection 138 between the first position 150 and the second position 160.

Returning to FIGS. 1-7, the first pair of brackets 126, 128 on the front rail assembly 104 align with the base portions 130a, 132a of the tracks 130, 132 on the rear rail assembly 106. For example, the first pair of brackets 126, 128 may be at the same vertical height (e.g., a distance from the surface upon which the ladder 100 rests) as the base portions 130a, 132a of the tracks 130, 132. The first base portion 130a of the first track 130 is disposed opposite the first bottom bracket 126. That is, the first base portion 130a is disposed at the same vertical height as the first bottom bracket 126. In some embodiments, the first base portion 130a is disposed at the same vertical height as the first bottom bracket opening 126a such the first rod 121a engages the first bottom bracket opening 126a and the first projection 136 rests on the first base portion 130a at the same vertical height. Additionally, the second base portion 132a of the second track 132 is disposed opposite the second bottom bracket 128. In some embodiments, the second base portion 132a of the second track 132 is disposed at the same vertical height as the second bottom bracket opening 128a such that the second rod 121b engages the second bottom bracket opening 128a and the second projection 138 rests on the second base portion 132a at the same vertical height when the platform 102 is at the first position 150.

Further, the second pair of brackets 122, 124 on the front rail assembly 104 align with the hooked portions 130b, 132b of the tracks 130, 132 on the rear rail assembly 106. For example, second pair of brackets 122, 124 may be at the same vertical height as the hooked portions 130b, 132b of the tracks 130, 132. The first top bracket 122 is disposed opposite the first hooked portion 130b of the first track 130. The second top bracket 124 is disposed opposite the second hooked portion 132b of the second track 132. In some embodiments, the point 130d of the first hooked portion 130b on the first track 130 is disposed at the same vertical height as the first top bracket 122. In particular, the point 130d may be disposed at the same vertical height as the first top bracket opening 122a such that the first rod 121a may engage the first top bracket opening 122a and the first projection 136 may engage the point 130d at the same vertical height. Additionally, the point 132d of the second hooked portion 132b on the second track 132 may be disposed opposite the second top bracket 124. In particular, the point 132d may be disposed at the same vertical height as the second top bracket opening 124a such that the second rod 121b may engage the second top bracket opening 124a and the second projection 138 may engage the point 132d at the same vertical height.

So configured, the first bottom bracket 126, the second bottom bracket 128, the first base portion 130a of the first track 130, and the second base portion 132a of the second track 132 secure the platform 102 in the first position 150 on the ladder 100. In particular, the first bottom bracket 126 and the second bottom bracket 128 engage the first rod 121a and the second rod 121b of the platform 102, respectively, to secure a front portion of the platform 102 to the front rail assembly 104 at the first position 150. The first base portion 130a of the first track 130 and the second base portion 132a of the second track 132 receive the first projection 136 and the second projection 138 of the platform 102, respectively, to secure a rear portion of the platform 102 to the rear rail assembly 106 at the first position 150. In this manner, a user has a flat, stable, and substantially horizontal adjustable platform on which to stand when the adjustable platform is locked into position.

Similarly, the first top bracket 122, the second top bracket 124, the first hooked portion 130b of the first track 130, and the second hooked portion 132b of the second track 132 secure the platform 102 in the second position 160 on the ladder 100. In particular, the first top bracket 122 and the second top bracket 124 engage the first rod 121a and the second rod 121b of the platform 102, respectively, to secure the front portion of the platform 102 to the front rail assembly 104 at the second position 160. The first hooked portion 130b of the first track 130 and the second hooked portion 132b of the second track 132 engage the first projection 136 and the second projection 138 of the platform 102, respectively, to secure a rear portion of the platform 102 to the rear rail assembly 106 at the second position 160. The points 130d, 132d of the hooked portions 130b, 132b of the tracks 130, 132 provide seats in which the projections 136, 138 of the platform 102 may rest in the second position 160. The bends of the hooked portions 130b, 132b of the tracks 130, 132 help to maintain the platform 102 in the second position 160, as a user would have to overcome the bends to return the platform 102 to the first position 150.

In some embodiments, the ladder 100 may further include one or more spreaders that extend between the front rail assembly 104 and the rear rail assembly 106. The spreaders may be horizontal bars or braces that are disposed between the front rail assembly 104 and the rear rail assembly 106. Spreaders may add stability, help to distribute weight across the ladder's support points, and/or may help to securely lock the ladder in an open position.

In the embodiment depicted in FIGS. 1-7, the platform 102 is shown in the first position 150 on the ladder 100. The lock assembly 120 is in the locked position, Accordingly, the first rod 121a is positioned in the first bottom bracket 126 and the second rod 121b is positioned in the second bottom bracket 128. The first projection 136 is seated in the first base portion 130a of the first track 130 and the second projection 138 is seated in the second base portion 132a of the second track 132.

It is contemplated that the platform 102 and/or the topmost step 114a may have any suitable size (thickness, width, length, etc.). The platform may be sized to conform with one or more ANSI requirements. In some approaches, the platform 102 may be sized to extend a specific distance beyond the rear rail assembly 106 when in the first position and/or when in the second position. In one example, the platform 102 and/or the topmost step 114a may be sized (e.g., have a particular width) to provide no overhang when in the first position. In another example, the platform 102 and/or the topmost step 114a may be sized (e.g., have a particular width) so that the platform 102 extends between about 0.5 inches and about 12 inches, between about 1 and about 6 inches, and, in some aspects, about 1.5 inches beyond the rear rail assembly 106 when in the first position and/or the second position. In some examples, the platform 102 and/or the topmost step 114a may be sized such that the platform extends beyond the rear rail assembly 106 by the same distance in the first position as in the second position.

In some approaches, the platform 102 may be extendable in one or more directions. The platform 102 may, for example, have an adjustable length such that a user may adjust the platform 102 to extend a desired distance beyond one or more of the front rail assembly 104 or the rear rail assembly 106. In one example, the platform 102 may have one or more telescoping sections that are able to extend from and retract into a stationary portion. Though, any suitable arrangement that provides adjustability may be employed.

In operation, a user may operate the pinch grasp portion 123 to move the lock assembly 120 from the locked position to the unlocked position. In the unlocked position, the first rod 121a is removed from the first bottom bracket 126 and the second rod 121b is removed from the second bottom bracket 128. As a result, the front portion of the platform 102 is free to move relative to the front rail assembly 104. When the front portion of the platform 102 is free from the front rail assembly 104, a user may push upward on the platform 102 to move the platform 102 to the second position 160 on the ladder 100. Pushing on or otherwise applying a force to the platform 102 may cause the rear portion of the platform 102 to slide along the tracks 130, 132 in the rear rail assembly 106. When the lock assembly 120 is in the unlocked position, the first projection 136 on the platform 102 is free to slide or travel along the first track 130 between the first position 150 and the second position 160. Likewise, in the unlocked position, the second projection 138 on the platform 102 is free to slide or travel along the second track 132 between the first position 150 and the second position 160. Sliding the projections 136, 138 along the tracks 130, 132 permits the rear portion of the platform 102 to travel along the rear rail assembly 106 such that the platform 102 is moveable between the first position 150 and the second position 160.

Although the topmost step 114a in FIGS. 1-7 has an extended portion that extends beyond the first front rail 108 and the second front rail 110, in some configurations, the topmost step 114a may be the same as the other steps 114. For example, the 114a may be flush with the flanges of the first front rail 108 and the second front rail 110. In such a configuration, the first pair of brackets (e.g., the first top bracket 122 and the second top bracket 124) may be coupled to the first front rail 108 and the second front rail 110, respectively, instead of being coupled to the extended portion of the topmost step 114a. FIGS. 15 and 16 illustrate an embodiment of a ladder so configured.

In some configurations, the ladder 100 may have a second pinch grasp portion on the rear portion of the platform 102 that is positioned adjacent to the rear rail assembly 104. The second pinch grasp portion may be configured to selectively engage the rear rail assembly 106. For example, the second pinch grasp portion may be coupled to the first projection 136 and to the second projection 138 and may be operable to retract the first projection 136 and the second projection 138 such that the disengage from the rear rail assembly 104 to allow the rear portion of the platform 102 to move relative to the ladder 100.

In yet other example configurations, the platform 102 may be completely removable from the ladder 100 such that a user can remove or insert the platform at a desired position along the ladder 100. The platform 102 may be removable by incorporating one or more pinch grasp portions that operate various pins, projections, etc. that engage openings, grooves, etc. in the rail assemblies of the ladder 100. For example, a user may be able to remove the platform 102 by disengaging the platform from the ladder 100 using a first pinch grasp portion operable to selectively engage the front rail assembly 104 and a second pinch grasp portion that is operable to selectively engage the rear rail assembly 106. The ladder 100 may have pairs of openings (or brackets having openings) disposed at various heights along the front rail assembly 104 and corresponding openings (or brackets having openings) disposed at various heights along the rear rail assembly 106 to permit the platform 102 to secured to the ladder at various heights. For example, a user may position the platform 102 at a desired height and secure the platform to the ladder 100 by engaging, via the pinch grasp portions, the pins, projections, etc. of the platform 102 with the opening (or brackets) at the desired height.

In some exemplary configurations, the front rail assembly 104 and the rear rail assembly 106 may have projections, pins, etc. that extend therefrom to engage openings in the platform 102. Thus, while the figures herein show male connectors (projections, pins, etc.) on the platform 102 engaging female connectors (openings, holes, tracks, grooves, etc.) in the rails or I n brackets coupled to the rails, it is contemplated that the platform 102 may also include one or more female connectors that engage male connectors on the rails.

Turning now to FIGS. 9-12, and adjustment of the platform 102 between the first position 150 and the second position 160 is shown.

In the first position 150, the platform 102 is disposed at the topmost step 114a of the ladder 100 such that the platform 102 is flush with a stepping surface of the topmost step 114a. In the second position 160, the platform 102 is disposed above the topmost step 114a. In some embodiments, the platform 102 is closer to a base of the ladder 100 in the first position 150 than in the second position 160. In some embodiments, the platform 102 is about 1 foot higher in the second position 160 than in the first position 150.

FIG. 9 shows the platform 102 of the ladder 100 of FIGS. 1-7 secured at the first position 150. In FIG. 9, the lock assembly 120 is in the locked position. Thus, the second rod 121b of the lock assembly 120 is seated in the second bottom bracket 128. Similarly, the 121a of the lock assembly 120 is seated in the first bottom bracket 126 (not visible in FIG. 9). The first projection 136 of the platform 102 is seated in the first base portion 130a of the first track 130. The second projection 138 of the platform 102 is seated in the second base portion 132a of the second track 132 (not visible in FIG. 9). A user may operate the pinch grasp portion 123 of the lock assembly 120 to place the lock assembly 120 in the unlocked position to adjust the platform 102.

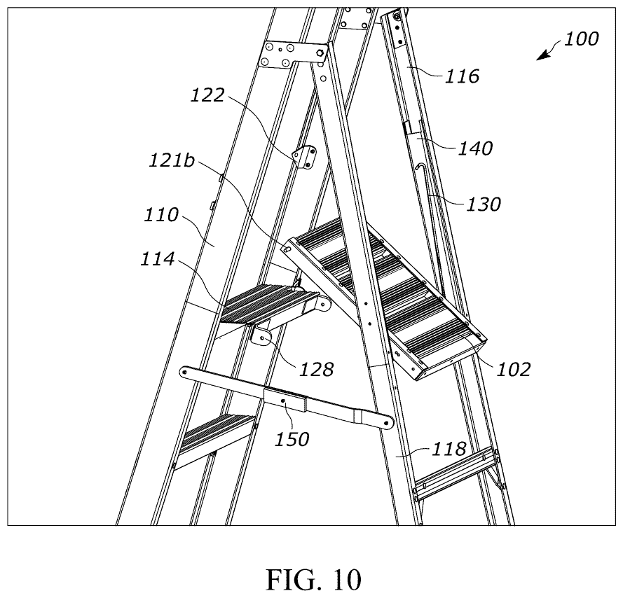

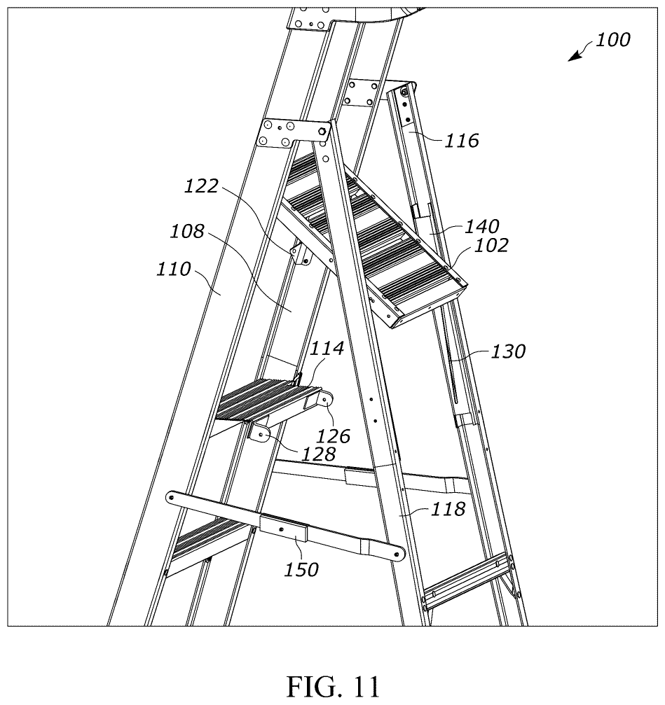

FIGS. 10 and 11 show the platform 102 of the ladder 100 of FIGS. 1-7 travelling between the first position 150 and the second position 160. In FIGS. 10 and 11, the lock assembly 120, is in the unlocked position. In the unlocked position, the first rod 121a is disengaged from the first bottom bracket 126 and the second rod 121b is disengaged from the second bottom bracket 128. Accordingly, it is possible to slide a rear portion of the platform 102 along the first track 130 and the second track 132 in order to adjust the height of the platform 102. As shown, an upward force such as the manual force of a user pushing, is being applied to the platform 102 to slide the platform 102 upward towards the second position 160.

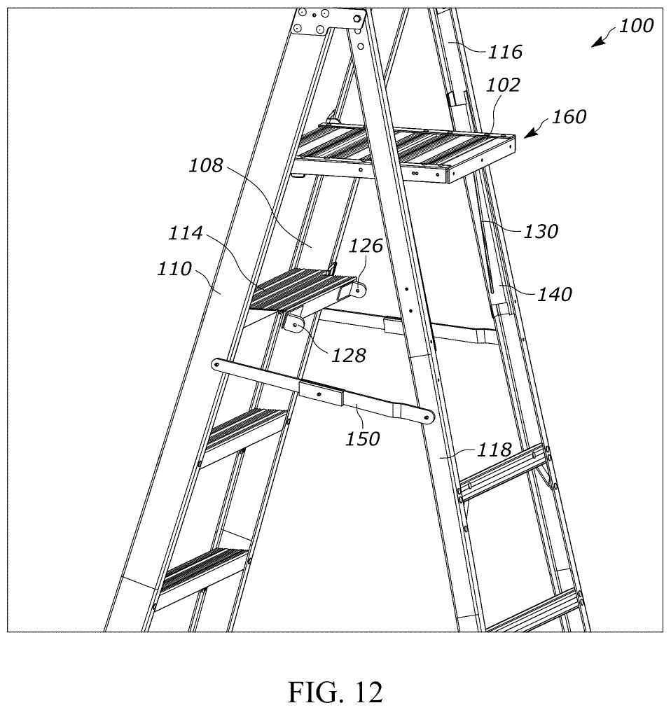

FIG. 12 shows the platform 102 of the ladder 100 of FIG. 1 secured at the second position 160. In FIG. 12, the lock assembly 120 is in the locked position. Thus, the 121a of the lock assembly 120 is seated in the first top bracket 122. Similarly, the second rod 121b of the lock assembly 120 is seated in the second top bracket 124 (not visible in FIG. 9). The first projection 136 of the platform 102 is seated in the point 130d of the first hooked portion 130b on the first track 130. The second projection 138 of the platform 102 is seated in point 132d of the second hooked portion 132b on the second track 132 (not visible in FIG. 9).

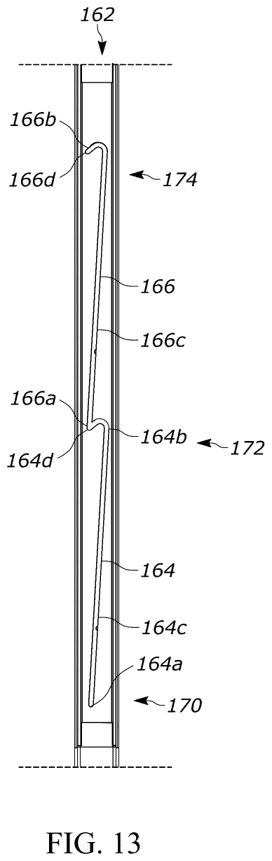

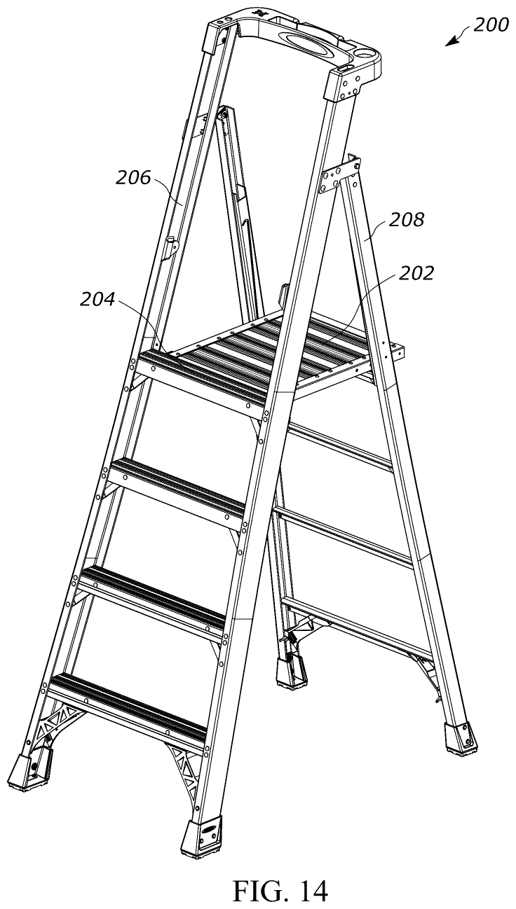

FIG. 13 illustrates an alternative embodiment for the tracks of the ladder 100. The track 162 includes a track having two candy-cane shaped portions that provide three secured positions. The track 162 may be included on the inward-facing portion of a ladder rail, for example, on the first rear rail 116 and/or second rear rail 118 of the rear rail assembly 106 of the ladder 100 of FIG. 1. In some embodiments, the track 162 may be formed in an insert that may be coupled to a rail.

The track 162 includes a first candy-cane shaped portion 164 arranged sequentially with a second candy-cane shaped portion 166. The second candy-cane shaped portion 164 has a base portion 164a, a hooked portion 164b, and a straight portion 164c extending therebetween. In some embodiments, the straight portion 164c is disposed at an angle relative to the edges (e.g., flanges) of a rail that includes the track 162. The second candy-cane shaped portion 166 includes a base portion 166a, a hooked portion 166b, and a straight portion 166c extending therebetween. In some embodiments, the straight portion 166c is disposed at an angle relative to the edges (e.g., flanges) of a rail that includes the track 162. A point 164d of the hooked portion 164b on the first candy-cane shaped portion 164 is coupled to the base portion 166a on the second candy-cane shaped portion 166. The point 164d and the base portion 166a form a generally U-shaped section.

A projection on a platform (not shown in FIG. 13), such as the first projection 136 or the second projection 138 described with reference to FIGS. 1-7, may be inserted into the track 162. The projection may be seated in a first secured position 170 in which the projection rests on the base portion 164a. The projection may also be seated in a second secured position 172 in which the projection rests on the U-shaped section formed at the intersection of the base portion 166a and the point 164d. Further, the projection may be seated in a third secured position 174 in which the projection rests on a point 166d of the hooked portion 166b of the second candy-cane shaped portion 166.

A user may slide the projection along the straight portion 164c of the first candy-cane shaped portion 164 to move the platform between the first secured position 170 and the second secured position 172. Similarly, a user may slide the projection along the straight portion 166c of the second candy-cane shaped portion 166 to move the platform between the second secured position 172 and the third secured position 174.

In some embodiments, the point 164d may be positioned about 1 foot above the base portion 166a. In some embodiments, the point 166d of the second candy-cane shaped portion 166 may be positioned about 1 foot above the base portion 166a. Though, it is contemplated that the distance between the base portion 164a and the point 164d and the distance between the base portion 166a and the point 166d may be any suitable distance and these two distances need not be the same. Further, the lengths of the straight portion 164c and the point 166d may be any suitable length. In some embodiments, the relative proportions of the first candy-cane shaped portion 164 and the second candy-cane shaped portion 166 may be selected to secure a platform at particular positions or heights on a ladder or other railed structure.

It is contemplated that, in yet other embodiments, the tracks described herein may include any number of candy-cane shaped portions or track configurations with multiple seating positions for the projections and platform. In addition, the ladder and tracks also may include any number corresponding brackets to provide any number of secured positions along a railed structure.

FIGS. 14 and 15 show an alternative configuration for an adjustable platform on a ladder 200. The components and functionality of the ladder 200 shown in FIGS. 14 and 15 are the same as the components and functionality the ladder 100 shown and described with reference to FIGS. 1-12, with the exception of the components expressly described below. One difference between the ladder 100 of FIGS. 1-12 and the ladder 200 of FIGS. 14 and 15 is that the topmost step 114a of the ladder 100 includes an extended portion that is not present on a topmost step 204 of the ladder 200. Instead, the topmost step 204 of the ladder 200 is flush with the rails of the front rail assembly 206.

The ladder 200 includes a front rail assembly 206 coupled to a rear rail assembly 208. A platform 202 is disposed between the front rail assembly 206 and the rear rail assembly 208. The platform 202 extends from the flange of the front rail assembly 206 to the rear rail assembly 208. In some configurations, the platform 202 extends beyond the rear rail assembly 208. The platform 202 may be sized to extend a specific distance beyond the rear rail assembly 208 when in the first position and the second position. On the ladder 200, brackets 210 are coupled directly to the rails of the front rail assembly 206, rather than to the topmost step 204.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular. Further, the rungs may have a hollow or substantially hollow cross-section.

The rungs of a ladder may be attached to the rails in a variety of different manners. In one approach, the rungs and rails are forged together, such as by having the rungs being attached to the rails via a direct swage connection. In a direct swage connection, a rung is attached directly to the rails using a cold forming process, where a moving die shapes the rung around a hole that was pre-punched in the rail. Annealing operations may be used to soften the metal to prevent cracking. In other approaches, the rungs are attached to the rails via a rung-plate connection in addition to other attachment types. In a rung-plate connection, a rung is attached to a plate and the plate is attached to the rail via one or more rivets or other mechanical elements.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee-caps may be riveted to the ladder.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A ladder comprising:
a front rail assembly including a first front rail and a second front rail spaced from and opposite the first front rail, a first pair of brackets coupled to the front rail assembly at a first position, and a second pair of brackets coupled to the front rail assembly at a second position;
a rear rail assembly coupled to the front rail assembly at a hinged portion, the rear rail assembly including a first rear rail having a first track and a second rear rail spaced from and opposite the first rear rail, the second rear rail having a second track that is opposite and aligned with the first track; and
a platform positioned between the front rail assembly and the rear rail assembly, the platform including a first projection that engages the first track and a second projection that engages the second track, such that the platform is moveable along the first track and the second track between the first position and the second position.

2. The ladder of claim 1, wherein the platform further includes a lock assembly having a locked position in which the platform is secured to the front rail assembly at the first position or the second position and an unlocked position in which the platform is moveable between the first position and the second position.

3. The ladder of claim 2, wherein the platform further includes a first rod and a second rod that engage the first pair of brackets or the second pair of brackets in the locked position.

4. The ladder of claim 3, wherein the lock assembly further includes a pinch grasp portion having a first lever and a second lever and the pinch grasp portion is operably coupled to the first rod and the second rod such the pinch grasp portion is operable to move the lock assembly between the locked position and the unlocked position.

5. The ladder of claim 1, wherein the first pair of brackets are coupled to a topmost step of a plurality of steps that are disposed between the first front rail and the second front rail and wherein the topmost step includes an extended portion that is cantilevered beyond the first front rail and the second front rail, the first pair of brackets being coupled to the extended portion of the topmost step.

6. A ladder comprising:
a front rail assembly including a first front rail and a second front rail spaced from and opposite the first front rail;
a rear rail assembly coupled to the front rail assembly at a hinged portion, the rear rail assembly including a first rear rail and a second rear rail spaced from and opposite the first rear rail;
a first pair of brackets disposed at a first position along the ladder and a second pair of brackets disposed at a second position along the ladder, the first pair of brackets and the second pair of brackets being coupled to one of the front rail assembly and the rear rail assembly;
a first track and a second track extending from the first position to the second position; and
a platform positioned between the front rail assembly and the rear rail assembly, the platform including a first projection that engages the first track and a second projection that engages the second track, such that the platform is moveable along the first track and the second track between the first position and the second position.

7. The ladder of claim 6, wherein the second track is spaced from and opposite the first track and the first track and the second track are formed on an inward-facing portion of the front rail assembly or the rear rail assembly.

8. A ladder comprising:
a rear rail assembly including a first rear rail having a first track and a second rear rail spaced from and opposite the first rear rail, the second rear rail having a second track that is opposite and aligned with the first track; and
a platform including a first projection that engages the first track and a second projection that engages the second track, such that the platform is moveable along the first track and the second track between a first position and a second position on the ladder.

9. The ladder of claim 8, wherein the first track is a first groove that serves as a guide for the first projection and the second track is second groove that serves as a guide for the second projection and the first projection is a first pin that engages the first groove and the second projection is a second pin that engages the second groove such that the first projection is moveable along the first track and the second projection is moveable along the second track.

10. The ladder of claim 8, wherein the first track is disposed on an inward-facing portion of the first rear rail and wherein the second track is disposed on an inward-facing portion of the second rear rail.

11. The ladder of claim 10, wherein the first track is formed in a first insert having a geometry corresponding to a geometry of the inward-facing portion of the first rear rail, and wherein the second track is formed in a second insert having a geometry corresponding to a geometry of an inward-facing portion of the second rear rail and wherein the first track is a first opening positioned between two parallel edges disposed in the first insert, and wherein the second track is a second opening positioned between two parallel edges disposed in the second insert.

12. The ladder of claim 8, wherein the first rear rail includes a first rear inner flange spaced from a first rear outer flange by a first rear web, the first track disposed between the first rear inner flange and the first rear outer flange, and wherein the second rear rail includes a second rear inner flange spaced from a second rear outer flange by a second rear web, the second track disposed between the second rear inner flange and the second rear outer flange.

13. The ladder of claim 12, wherein the first rear inner flange, the first rear outer flange, and the first rear web form a first channel and the first track is disposed in a first insert in the first channel; and
wherein the second rear inner flange, the second rear outer flange, and the second rear web form a second channel and the second track is disposed in a second insert in the second channel.

14. The ladder of claim 8, wherein the first track has a candy-cane shape, and wherein the second track has a candy-cane shape that is aligned with the candy-cane shape of the first track.

15. The ladder of claim 8, wherein the first track includes a first base portion, a first hooked portion, and first straight portion disposed therebetween, and wherein the second track includes a second base portion, a second hooked portion, and a second straight portion disposed therebetween.

16. The ladder of claim 15, wherein the first hooked portion of the first track and the second hooked portion of the second track are disposed at the second position, and wherein the first base portion of the first track and the second base portion of the second track are disposed at the first position.

17. The ladder of claim 15, wherein first straight portion of the first track is disposed at an angle relative to the first rear rail, and wherein the second straight portion of the second track is disposed at an angle relative to the second rear rail.

18. The ladder of claim 15, wherein the first track is disposed between a first rear inner flange and a first rear outer flange of the first rear rail, the first base portion of the first track being closer to the first rear inner flange than a bend of the first hooked portion, and
wherein the second track is disposed between a second rear inner flange and a second rear outer flange of the second rear rail, the second base portion of the second track being closer to first rear inner flange than a bend of the second hooked portion.

19. The ladder of claim 8, further comprising:
a front rail assembly coupled to the rear rail assembly via a hinged portion, the front rail assembly including:
a first pair of brackets disposed at the first position;
a second pair of brackets disposed at the second position, wherein the front rail assembly includes a plurality of steps disposed therebetween; and
a spreader coupled to the front rail assembly and the rear rail assembly adjacent to the first track and the second track; and
wherein, the first pair of brackets are coupled to a step of the front rail assembly and where the first pair of brackets include a first bottom bracket disposed opposite a base portion of the first track and a second bottom bracket disposed opposite a base portion of the second track; and
wherein the second pair of brackets includes a first top bracket disposed opposite a top portion of the first track and a second top bracket disposed opposite a top portion of the second track.

20. The ladder of claim 19, wherein the platform further includes a lock assembly to secure the platform to the front rail assembly, wherein the lock assembly includes a first rod and the first bottom bracket includes a first bottom bracket opening to receive the first rod, and wherein the lock assembly further includes a second rod and the second bottom bracket includes a second bottom bracket opening to receive the second rod.

21. The ladder of claim 20, wherein the first top bracket includes a first top bracket opening to receive the first rod, and wherein the second top bracket includes a second top bracket opening to receive the second rod.

22. The ladder of claim 8, wherein the platform is moveable along the first track and the second track between a second position and a third position and the first track includes a first hooked portion disposed at the second position and a second hooked portion disposed at the third position, and wherein the second track includes a first hooked portion disposed at the second position and a second hooked portion disposed at the third position.
